(19) United States
(12) Patent Application Publication
(10) Pub. No.: US 2024/0328065 A1
(43) Pub. Date: Oct. 3, 2024

(54) FILTER ASSEMBLY AND WASHING MACHINE COMPRISING SAME

(71) Applicant: SAMSUNG ELECTRONICS CO., LTD., Suwon-si (KR)

(72) Inventors: Seulgi LEE, Suwon-si (KR); Seungil LIM, Suwon-si (KR); Younghyun KIM, Suwon-si (KR)

(73) Assignee: SAMSUNG ELECTRONICS CO., LTD., Suwon-si (KR)

(21) Appl. No.: 18/743,409

(22) Filed: Jun. 14, 2024

Related U.S. Application Data
(63) Continuation of application No. PCT/KR2022/017561, filed on Nov. 9, 2022.

(30) Foreign Application Priority Data
Jan. 3, 2022 (KR) 10-2022-0000469

(51) Int. Cl. D06F 58/22; B01D 46/00; B01D 46/42

(52) U.S. Cl. CPC D06F 58/22; B01D 46/0006; B01D 46/4227

(57) ABSTRACT

A washing machine is disclosed. The present washing machine comprises: a main body; a tub provided inside the main body; an inflow duct in through which air discharged from the tub flows; a heat exchange duct connected to the inflow duct; a discharge duct for connecting the heat exchange duct and the tub, and discharging, to the tub, the air discharged from the heat exchange duct; and a filter assembly disposed between the inflow duct and the heat exchange duct, wherein the filter assembly includes: a polyhedral filter housing receiving the air from the inflow duct; filters arranged at at least three sides of the filter housing; and a knob member connected to the filter housing, and exposed to the outside of the main body through an opening formed at the front of the main body.

### CROSS-REFERENCE TO RELATED APPLICATIONS

This application is a continuation of International Application PCT/KR2022/017561, filed Nov. 9, 2022, and claims foreign priority to Korean Application 10-2022-0000469, filed Jan. 3, 2022, which are incorporated herein by reference in their entireties.

### TECHNICAL FIELD

The disclosure relates to a filter assembly and a washing machine comprising the same, and more particularly, to a filter assembly for filtering lint generated while performing a drying function in a washing machine with drying function and a washing machine comprising the same.

### BACKGROUND ART

Washing machines for washing laundry and dryers for drying laundry have been formed as separate devices. However, when washing machines and dryers are formed as separate devices as described above, there has been an inconvenience for users having to wait until the laundry is completed and then having to move the washing completed laundry to a dryer.

To solve the inconvenience described above, washing machines with drying function are being developed recently. Accordingly, there has been a growing need for technology of effectively filtering lint generated from the laundry when performing the drying function in a washing machine with drying function.

### DISCLOSURE

### Technical Solution

The disclosure has been devised to solve the above-described necessity, and an object of the disclosure lies in providing a filter assembly including a performance improved filter structure which filters lint and is configured to pull out from a front surface of a washing machine and a washing machine comprising the same.

To achieve the object as described above, according to an embodiment of the disclosure, a washing machine includes a main body, a tub at an inside of the main body, an inlet duct through which air discharged from the tub is introduced, a heat exchange duct connected with the inlet duct so that the air introduced through the inlet duct flows through the heat exchange duct, a discharge duct connecting the heat exchange duct with the tub so that the air flowed through the heat exchange duct is discharged to the tub, and a filter assembly between the inlet duct and the heat exchange duct. The filter assembly includes a filter housing formed as a polyhedron and configured to receive the air introduced through the inlet duct, filters disposed on at least three different surfaces forming different faces of the filter housing to filter the air received by the filter housing, and a handle connected with the filter housing and exposed to an outside of the main body through an opening formed at a front surface of the main body.

The filter assembly may include an inlet port at a rear surface of the filter housing and through which the air introduced through the inlet duct is received by the filter housing, a first discharge port at a side surface of the filter housing facing the heat exchange duct, a second discharge port at a top surface of the filter housing, and a third discharge port at a bottom surface of the filter housing.

The filters may be respectively disposed at the first discharge port, the second discharge port, and the third discharge port.

The handle may include a handle cover exposed to the front surface of the main body, a lever at a back surface of the handle cover and rotatable based on a rotation axis positioned at an opposite end thereof when one end thereof is pressed in a front surface direction, and a hook connected with an opposite end of the lever. The main body may include an engagement projection which is fastened with the hook when the lever is not in a pressed state, and the hook may be released from being fastened with the engagement projection when the lever is pressed in the front surface direction.

The filter assembly may be pulled out to the outside of the main body through an opening of the main body when the lever is pressed in the front surface direction.

The filter assembly may be at an upper part of the tub.

A direction to which air is discharged from the filter assembly to the heat exchange duct may be a direction perpendicular to a direction to which air is introduced through the inlet port.

According to an embodiment of the disclosure, a filter assembly installed in a washing machine includes a filter housing formed as a polyhedron and configured to receive air introduced through an inlet port, filters disposed on at least three different surfaces forming different faces of the filter housing, and a handle connected with the filter housing and exposed to an outside of a main body of the washing machine through an opening formed at a front surface of the main body.

The filter assembly may include a first discharge port at a side surface of the filter housing, a second discharge port at a top surface of the filter housing, and a third discharge port at a bottom surface of the filter housing.

### DESCRIPTION OF DRAWINGS

FIG. 1 is a perspective view illustrating an exterior of a washing machine according to an embodiment of the disclosure;

FIG. 2 is a view illustrating a drying device installed in a washing machine according to an embodiment of the disclosure;

FIG. 3 is a view conceptually illustrating a drying device of a washing machine according to an embodiment of the disclosure;

FIG. 4 is a view illustrating a filter assembly separated from a drying device according to an embodiment of the disclosure;

FIG. 5 is an exploded perspective view of a filter assembly according to an embodiment of the disclosure;

FIG. 6 is a cross-sectional view cut along A-A in FIG. 2 while a filter assembly is fastened to a main body of a washing machine according to an embodiment of the disclosure; and

FIG. 7 is a view illustrating fastening of a filter assembly and a main body released by a lever in FIG. 6 being pressed.

### DETAILED DESCRIPTION OF EXEMPLARY EMBODIMENTS

Embodiments described below are provided as examples to assist in understanding of the disclosure, and it is to be understood that the disclosure may be variously modified and realized, unlike the embodiments described herein. However, in describing the disclosure, in case it is determined that the detailed description of related known technologies may unnecessarily confuse the gist of the disclosure, the detailed description thereof and the detailed drawing thereof will be omitted. In addition, the accompanied drawing may be shown exaggerated in measurement of some elements rather than being shown according to its actual dimension to assist in the understanding of the disclosure.

Terms used in the disclosure and the claims are general terms selected considering their function herein. However, the terms may change depending on intention, legal or technical interpretation, emergence of new technologies, and the like of those skilled in the related art. In addition, there may be terms arbitrarily selected. The terms described above may be interpreted according to the meaning defined in the disclosure, and if no specific definition is described, the meaning of the term may be interpreted based on the overall context of the disclosure and technical sense common in the corresponding technical field.

In describing the disclosure, an order of each step is to be understood as non-limiting unless the order of each step needs to be performed such that a preceding step must be performed logically and temporally prior to a following step. That is, except for exceptional cases as described above, even if a process described as the following step is performed preceding a process described as the preceding step, it does not influence the nature of the disclosure and the scope of protection should also be defined regardless of the order of the step.

In the disclosure, expressions such as “have,” “may have,” “include,” and “may include” are used to designate a presence of a corresponding characteristic (e.g., elements such as numerical value, function, operation, or component), and not to preclude a presence or a possibility of additional characteristics.

The terms such as “first,” “second,” and so on may be used to describe a variety of elements, but the elements should not be limited by these terms. The terms may be used only for the purpose of distinguishing one element from another. For example, a first element may be designated as a second element without departing from the scope and spirit of the present disclosure, and similarly, the second element may also be designated as the first element.

In addition, terms such as ‘front surface,’ ‘rear surface,’ ‘top surface,’ ‘bottom surface,’ ‘side surface,’ ‘left side,’ ‘right side,’ ‘upper part,’ ‘lower part,’ and the like used in the disclosure may be defined based on the drawings, and forms and locations of each element are not limited by these terms.

Further, because elements necessary in describing each embodiment of the disclosure are described in the disclosure, the embodiments are necessarily not limited thereto. Accordingly, some elements may be modified or omitted, and other elements may be added. In addition, the elements may be distributed to devices independent from one another and disposed.

Furthermore, although embodiments of the disclosure have been described in detail below with reference to the accompanied drawings and the descriptions of the accompanied drawings, the disclosure is not limited to the embodiments.

The disclosure will be described in greater detail below with reference to the drawings.

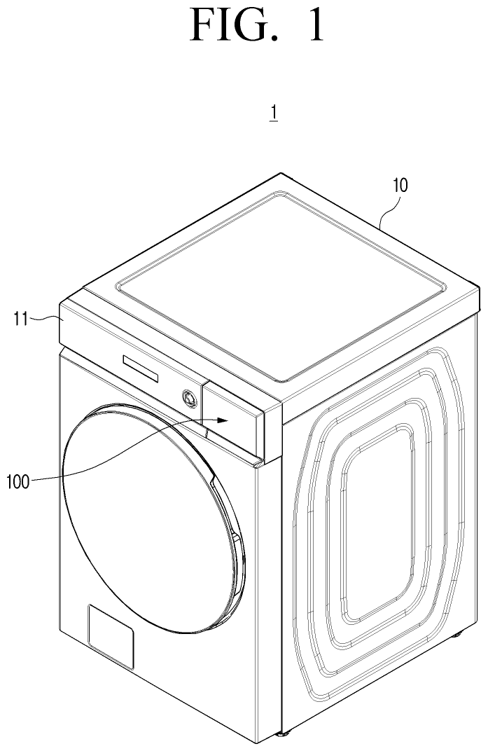

FIG. 1 is a perspective view illustrating an exterior of a washing machine according to an embodiment of the disclosure.

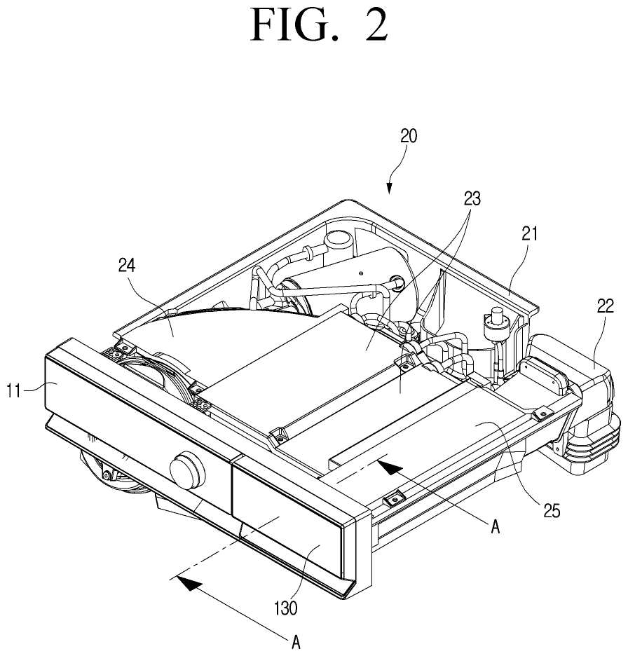

A washing machine 1 according to an embodiment of the disclosure may include a main body 10 which forms an exterior, and a tub (not shown), a drum (not shown), and a drying device 20 (referring to FIG. 2) may be included in an inside of the main body 10.

At a front cover 11 of the main body 10, a laundry insertion hole through which laundry is inserted to the inside of the main body 10 and a door capable of opening and closing the laundry insertion hole may be installed.

The tub (not shown) may be installed inside the main body 10 and formed in a hollow cylindrical shape provided with an opening toward the laundry insertion hole, and the drum (not shown) may be installed to be rotatable inside the tub and formed in a hollow cylindrical shape so as to accommodate laundry.

The drying device 20 may be disposed at an upper part of the tub, heat and dry air discharged from the tub, and dry the laundry accommodated inside the drum by circulating dry air of high-temperature to the inside of the tub.

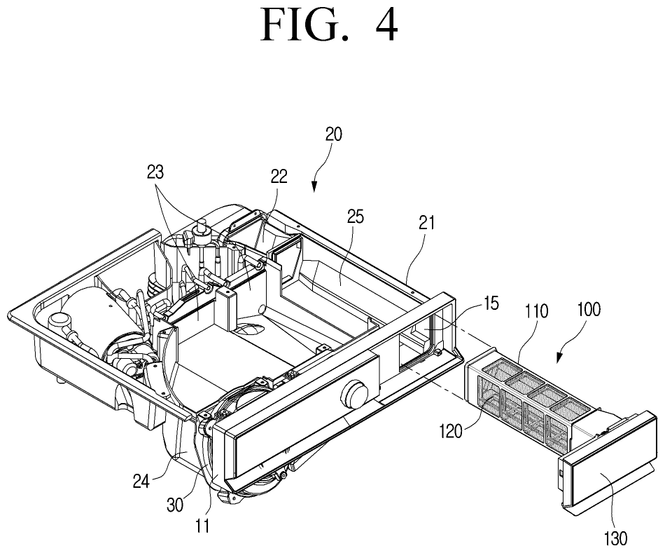

A filter assembly 100 may be disposed inside the drying device 20, pulled out to an outside the main body 10 through an opening 15 (referring to FIG. 4) formed at the front cover 11

FIG. 2 is a view illustrating a drying device installed in a washing machine according to an embodiment of the disclosure.

The drying device 20 may be disposed inside the main body 10, and disposed at the upper part of the tub. Referring to FIG. 2, the drying device 20 may include a drying device housing 21, an inlet duct 22, a heat exchange duct 23, a discharge duct 24, and a filter accommodating part 25.

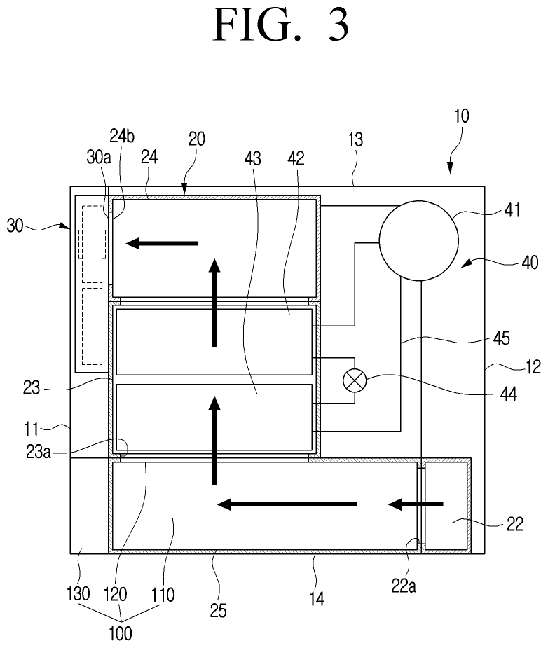

Configurations which constitute the drying device 20 may be accommodated inside the drying device housing 21. The above will be described in detail with reference to FIG. 3.

The inlet duct 22 may be connected with the tub and air discharged from the tub may be introduced therethrough.

Air which passed the inlet duct 22 may move to the heat exchange duct 23 passing through the filter assembly 100 which is disposed inside the filter accommodating part 25. Air introduced to the heat exchange duct 23 may be discharged to the tub through a discharge duct 24 in a high-temperature dried state by being dehumidified and heated by a heat pump 40 (referring to FIG. 3).

The filter assembly 100 may include a handle 130 which is exposed to the outside of the main body 10. A user may pull out the filter assembly 100 from the main body 10 by pulling the handle 130 in a front surface direction of the main body 10. Detailed descriptions associated with the filter assembly 100 will be described below with reference to the drawings.

FIG. 3 is a view conceptually illustrating a drying device of a washing machine according to an embodiment of the disclosure.

Referring to FIG. 3, the drying device 20 may include the inlet duct 22 which forms a flow path connecting a front direction and a rear direction of the tub, the filter accommodating part 25, the heat exchange duct 23, and the discharge duct 24, and include a blower fan 30 which generates airflow circulating the flow path, and the heat pump 40 for removing and heating moisture included in the air that passed the drum, and changing to dry air.

The heat pump 40 may be formed to change to high-temperature dry air by removing and heating the moisture in the air that flows along the flow path formed inside the drying device 20. The heat pump 40 may include a compressor 41, a condenser 42, an evaporator 43, and an expansion valve 44. In addition, the heat pump 40 may include a refrigerant pipe 45 which connects the compressor 41, the condenser 42, the evaporator 43, and the expansion valve 44 for refrigerant to circulate.

The heat pump 40 may remove the moisture contained in the air and heat the air heat exchanging the refrigerant circulating through the condenser 42, the expansion valve 44, and the evaporator 43 with the air by the compressor 41.

The evaporator 43 and the condenser 42 may be installed at the heat exchange duct 23. The evaporator 43 and the condenser 42 may be installed so as to be spaced apart by a certain distance, and the condenser 42 may be installed at a downstream of the evaporator 43 in a circulating direction of the airflow.

The evaporator 43 may be connected with the inlet duct 22 through the filter assembly 100 which is disposed inside the filter accommodating part 25, and may remove the moisture by cooling the humid air discharged from the tub.

The condenser 42 may be connected with the blower fan 30, and may heat air by emitting heat to the air discharged to the tub. Accordingly, the blower fan 30 may discharge dry air of high-temperature to the tub.

The compressor 41 may be installed in a space provided between the discharge duct 24 and a rear cover 12 of the main body 10.

Accordingly, the washing machine 1 with drying function according to an embodiment of the disclosure which has the structure described above may form, based on the blower fan 30 operating, an airflow with the air inside the drum, and may be introduced back to the inside of the drum after passing the inlet duct 22, the filter assembly 100, the heat exchange duct 23, and the discharge duct 24.

At this time, the heat pump 40 may operate removing the moisture in the air discharged from the drum, and raise temperature of air. That is, the moisture in the air may be removed by the evaporator 43 of the heat pump 40, and the temperature of air may increase due to the condenser 42. The high-temperature dry air may dry the laundry placed in the drum by being supplied to the drum by the blower fan 30.

FIG. 4 is a view illustrating a filter assembly separated from a drying device according to an embodiment of the disclosure. The dry air of high-temperature may be supplied to the drum by the blower fan 30 and dry the laundry placed inside the drum.

Referring to FIG. 4, the filter assembly 100 may include a filter housing 110, filters 120, and the handle 130.

The filter housing 110 may receive introduction of air from the inlet duct 22, and may be formed as a polyhedron. For example, the filter housing 110 may have a rough rectangular parallelepiped shape.

The filters 120 may perform filtering of foreign materials included in the air introduced through the inlet duct 22. The filters 120 may be disposed on at least three surfaces forming different faces of the filter housing 110. For example, if the filter housing 110 has a rectangular parallelepiped shape, the filters 120 may be formed at a side surface facing with an inlet of the heat exchange duct 23 from among the side surfaces of the filter housing 110, and disposed additionally at each of the top surface and the bottom surface of the filter housing 110.

The handle 130 may be connected with the filter housing 110 and exposed to the outside of the main body 10. The user may pull out the filter assembly 100 by pulling the handle 130 to the outside through the opening 15 formed at the front cover 11 of the main body 10.

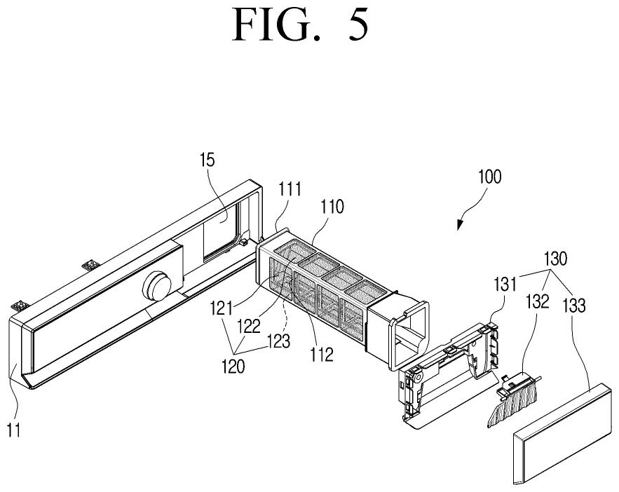

FIG. 5 is an exploded perspective view of a filter assembly according to an embodiment of the disclosure.

The filter assembly 100 may be formed at a rear surface of the filter housing 110 and may include an inlet port 111 through which air is introduced from the inlet duct 22, and a first discharge port 11 formed at a side surface facing with the heat exchange duct 23 in the filter housing 110. The filter assembly 100 may additionally include a second discharge port formed at the top surface of the filter housing, and a third discharge port formed at the bottom surface of the filter housing 110. At each of the discharge ports, filters 121, 122, and 123 may be disposed.

The handle 130 may include a handle housing 131 which is connected with the filter housing 110, a handle cover 133 exposed to a front surface of the main body 10, and a lever 132 which is disposed at a back surface of the handle cover 133 and rotated based on a rotation axis which is positioned at an opposite end thereof when one end thereof is pressed in the front surface direction. The user may press the lever 132 and release a fastened state between the filter assembly 100 and the main body 10.

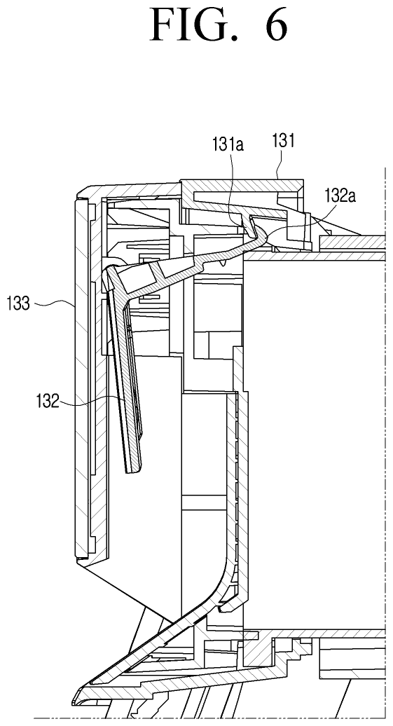

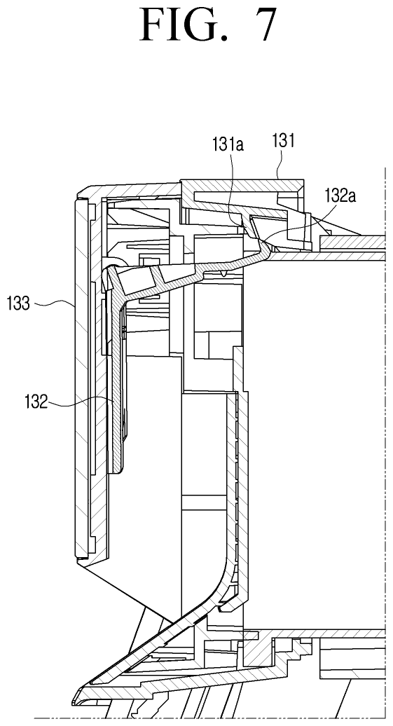

FIG. 6 is a cross-sectional view cut along A-A in FIG. 2 while a filter assembly is fastened to a main body of a washing machine according to an embodiment of the disclosure, and FIG. 7 is a view illustrating fastening of a filter assembly and a main body released by a lever in FIG. 6 being pressed.

Referring to FIG. 6 and FIG. 7, the lever 132 may include a hook 132a which is connected to an opposite end of the rotation axis, and an engagement projection 131a which is fastened with the hook 132a when the lever 132 is not in a pressed state (state in FIG. 6) may be formed at the main body 10.

Referring to FIG. 7, if the lever 132 is pressed in the front surface direction, the hook 132a may be released from fastening with the engagement projection 131a by rotation of the lever 132. Accordingly, if the lever 132 is pressed in the front surface direction, the filter assembly 100 may be pulled out to the outside of the main body 10.

While the disclosure has been illustrated and described with reference to various example embodiments thereof, it will be understood that the various example embodiments are intended to be illustrative, not limiting. It will be understood by those skilled in the art that various changes in form and details may be made therein without departing from the true spirit and full scope of the disclosure, including the appended claims and their equivalents.

What is claimed is:

1. A washing machine, comprising:
a main body;
a tub inside the main body;
an inlet duct through which air discharged from the tub is introduced;
a heat exchange duct connected with the inlet duct so that the air introduced through the inlet duct flows through the heat exchange duct;
a discharge duct connecting the heat exchange duct with the tub so that the air flowed through the heat exchange duct is discharged to the tub; and
a filter assembly between the inlet duct and the heat exchange duct, wherein the filter assembly includes:
a filter housing formed as a polyhedron and configured to receive the air introduced through the inlet duct,
filters disposed on at least three different surfaces forming different faces of the filter housing to filter the air received by the filter housing, and
a handle connected with the filter housing and exposed to an outside of the main body through an opening formed at a front surface of the main body.

2. The washing machine of claim 1, wherein the filter assembly includes:
an inlet port at a rear surface of the filter housing and through which the air introduced through the inlet duct is received by the filter housing,
a first discharge port at a side surface of the filter housing facing the heat exchange duct,
a second discharge port at a top surface of the filter housing, and
a third discharge port at a bottom surface of the filter housing.

3. The washing machine of claim 2, wherein the filters are respectively disposed at the first discharge port, the second discharge port, and the third discharge port.

4. The washing machine of claim 1, wherein
the handle includes:
a handle cover exposed to the front surface of the main body,
a lever at a back surface of the handle cover and rotatable based on a rotation axis positioned at an opposite end of the lever when one end of the lever is pressed in a front surface direction, and
a hook connected with the opposite end of the lever,
the main body includes an engagement projection which is fastened with the hook when the lever is not in a pressed state, and
the hook is released from being fastened with the engagement projection when the lever is pressed in the front surface direction.

5. The washing machine of claim 4, wherein the filter assembly is pulled out to the outside of the main body through an opening of the main body when the lever is pressed in the front surface direction.

6. The washing machine of claim 1, wherein the filter assembly is at an upper part of the tub.

7. The washing machine of claim 2, wherein a direction to which air is discharged from the filter assembly to the heat exchange duct is a direction perpendicular to a direction to which air is introduced through the inlet port.

8. A filter assembly installed in a washing machine, the filter assembly comprising:
a filter housing formed as a polyhedron and configured to receive air introduced through an inlet port;
filters disposed on at least three different surfaces forming different faces of the filter housing; and
a handle connected with the filter housing and exposed to an outside of a main body of the washing machine through an opening formed at a front surface of the main body.

9. The filter assembly of claim 8, wherein the filter assembly includes:
a first discharge port at a side surface of the filter housing,
a second discharge port at a top surface of the filter housing, and
a third discharge port at a bottom surface of the filter housing.

10. The filter assembly of claim 9, wherein the filters are respectively disposed at the first discharge port, the second discharge port, and the third discharge port.

11. The filter assembly of claim 8, wherein
the handle includes:
a handle cover exposed to the front surface of the main body,
a lever at a back surface of the handle cover and rotatable based on a rotation axis positioned at an opposite end of the lever when one end of the lever is pressed in a front surface direction, and
a hook connected with an opposite end of the lever,
the main body includes an engagement projection which is fastened with the hook when the lever is not in a pressed state, and
the hook is released from being fastened with the engagement projection when the lever is pressed in the front surface direction.
